(19) United States
(12) Patent Application Publication
(10) Pub. No.: US 2019/0235297 A1
(43) Pub. Date: Aug. 1, 2019

(54) EMBOSSING PLATE AND MANUFACTURING METHOD THEREOF, AND ALIGNMENT LAYER TRANSFER PLATE AND MANUFACTURING METHOD THEREOF

(71) Applicants: BEIJING BOE DISPLAY TECHNOLOGY CO., LTD., Beijing (CN); BOE TECHNOLOGY GROUP CO., LTD., Beijing (CN)

(72) Inventors: Guojing MA, Beijing (CN); Changjian XU, Beijing (CN); Jinyu REN, Beijing (CN); Sha FENG, Beijing (CN)

(21) Appl. No.: 16/140,142

(22) Filed: Sep. 24, 2018

(30) Foreign Application Priority Data
Jan. 26, 2018 (CN) 201810076923.3

(51) Int. Cl. G02F 1/1337; B44B 5/02; B29C 59/04

(52) U.S. Cl. CPC G02F 1/13378; B44B 5/0009; B29C 59/046; B44B 5/026

(57) ABSTRACT

Embodiments of the present disclosure provide an embossing plate and a manufacturing method thereof, and an alignment layer transfer plate and a manufacturing method thereof. The embossing plate includes an embossing plate body, and a plurality of protrusions distributed in an array are formed on an embossing surface of the embossing plate body. The embossing plate according to the present disclosure can improve a thickness uniformity of the alignment layer and a quality of the surface of the alignment layer.

### CROSS-REFERENCE TO RELATED APPLICATIONS

The present disclosure claims priority of Chinese Patent Application No. 201810076923.3, filed on Jan. 26, 2018 with State Intellectual Property Office in China, entitled “EMBOSSING PLATE AND MANUFACTURING METHOD THEREOF, ALIGNMENT LAYER TRANSFER PLATE AND MANUFACTURING METHOD THEREOF”, the entirety of which is incorporated herein by reference.

### FIELD OF THE INVENTION

The present disclosure relates to the field of printing technologies, and in particular, to an embossing plate and a manufacturing method thereof, and an alignment layer transfer plate and a manufacturing method thereof.

### BACKGROUND

In a liquid crystal display device, in order to obtain a uniform brightness and a high contrast, liquid crystal molecules in a liquid crystal panel are necessarily aligned in a certain direction. In order to align the liquid crystal molecules in a certain direction, for example, an alignment layer may be provided on a substrate. However, the surface pattern uniformity of an alignment layer transfer plate in the related art is insufficient, resulting in unevenness of patterns formed on an alignment layer. The uniformity of the alignment layer has attracted wide attention.

### SUMMARY

Embodiments of the disclosure provide an embossing plate and a manufacturing method thereof, and an alignment layer transfer plate and a manufacturing method thereof.

According to the first aspect of the present disclosure, in an embodiment, there is provided an embossing plate for manufacturing an alignment layer transfer plate, wherein the embossing plate comprises an embossing plate body, and a plurality of protrusions distributed in an array are provided on an embossing surface of the embossing plate body.

Optionally, a plurality of through holes distributed in an array are formed on the embossing plate body, a filler is provided within each of the through holes, and a portion of the filler protrudes from the embossing surface of the embossing plate body to form the protrusions.

Optionally, a first embossing surface and a second embossing surface are formed on both sides of the embossing plate body, respectively, and two portions of the filler protrude from the first embossing surface and the second embossing surface of the embossing plate body, respectively.

Optionally, the filler is in a shape of sphere.

Optionally, the filler is made from metal or glass.

Optionally, a colloid adhesive is applied between the through hole and the filler to fix the filler within the through hole.

According to the second aspect of the disclosure, in an embodiment, there is further provided an alignment layer transfer plate, comprising a substrate and a transfer layer disposed on the substrate, wherein patterns are formed on the transfer layer by using the above embossing plate according to the present disclosure.

Optionally, a portion of the substrate on both sides of the transfer layer is provided with a clamp region; a plurality of stoppers are evenly distributed in the clamp region; a plurality of concave portions are correspondingly provided on the clamp for fixing the substrate; and under the condition that the clamp is mounted to the substrate, the stoppers are engaged with the respective concave portions.

Optionally, the stopper is in a columnar or a tapered shape.

Optionally, the stopper is integrally formed with the transfer layer.

According to the third aspect of the disclosure, in an embodiment, there is further provided a method for manufacturing embossing plate, comprising steps of: providing an embossing plate body; and forming a plurality of protrusions distributed in an array on an embossing surface of the embossing plate body.

Optionally, the step of providing an embossing plate body further comprises: forming a plurality of through holes distributed in an array on the embossing plate body. The step of forming a plurality of protrusions distributed in an array on an embossing surface of the embossing plate body further comprises: providing a filler within each of the through holes such that a portion of the filler protrudes from the embossing surface of the embossing plate body to form the protrusions.

Optionally, the step of providing a filler within each of the through holes further comprises: providing a liquid adhesive between the through hole and the filler; and curing the liquid adhesive to form a colloid adhesive.

According to the fourth aspect of the disclosure, in an embodiment, there is provided a method for manufacturing an alignment layer transfer plate, comprising steps of: providing a substrate; forming a transfer layer in a liquid state on the substrate; placing the embossing plate according to the present disclosure on the transfer layer; curing the transfer layer; and separating the embossing plate from the transfer layer to form patterns on the transfer layer.

Optionally, before placing the embossing plate on the transfer layer, the method further comprises: providing an embossing plate body; and forming a plurality of protrusions distributed in an array on an embossing surface of the embossing plate body.

### BRIEF DESCRIPTION OF THE DRAWINGS

FIG. 1 is a schematic diagram showing the manufacturing of an alignment layer transfer plate in the related art;

FIG. 2 is a schematic diagram showing an alignment layer pattern manufactured by using the alignment layer transfer plate in the related art;

FIG. 3A is a top plan view of an embossing plate according to an embodiment of the present disclosure;

FIG. 3B is a cross-sectional view taken along a line A-A of FIG. 3A;

FIG. 4A is a schematic diagram showing the manufacturing of an alignment layer transfer plate by using the embossing plate according to the embodiment of the present disclosure;

FIG. 4B is a diagram showing a structure of the alignment layer transfer plate manufactured by using the embossing plate according to the embodiment of the present disclosure;

FIG. 5 is a cross-sectional view of the embossing plate according to an embodiment of the present disclosure;

FIG. 6A is a top plan view of the alignment layer transfer plate according to the embodiment of the present disclosure;

FIG. 6B is a cross-sectional diagram taken along a line B-B of FIG. 6A;

FIG. 7A is a diagram of a structure of a clamp used in an embodiment of the present disclosure; and

FIG. 7B is a diagram showing an installation of the clamp used in the embodiment of the present disclosure.

### DETAILED DESCRIPTION OF THE EMBODIMENTS

In order to make those skilled in the art better understand the technical solutions of the present disclosure, an embossing plate and a method of manufacturing the same, and an alignment layer transfer plate and a method of manufacturing the same provided in the present disclosure will be described in detail hereinafter with reference to the accompanying drawings.

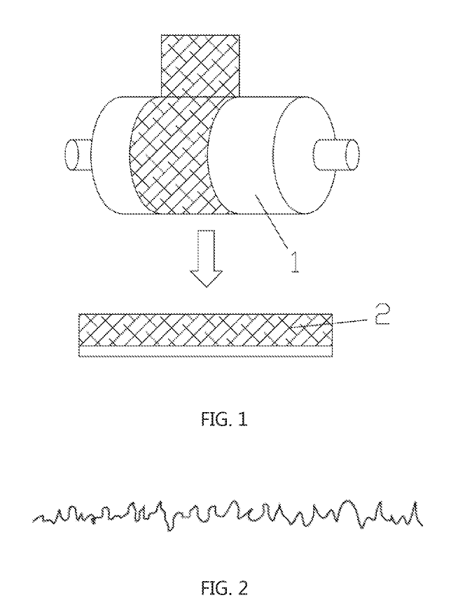

As shown in FIG. 1, in the manufacturing method of the alignment layer transfer plate in the related art, a roller 1 having patterns is pressed against a surface of a resin 2, and portions without patterns are removed by laser, thereby forming an alignment layer transfer plate having desired patterns.

However, it has been found during the research that an accuracy of the surface of the resin 2 is uncontrollable due to irregular roughness of the surface of the roller 1. As shown in FIG. 2, the uniformity of the patterns on the surface of the resin 2 is inferior.

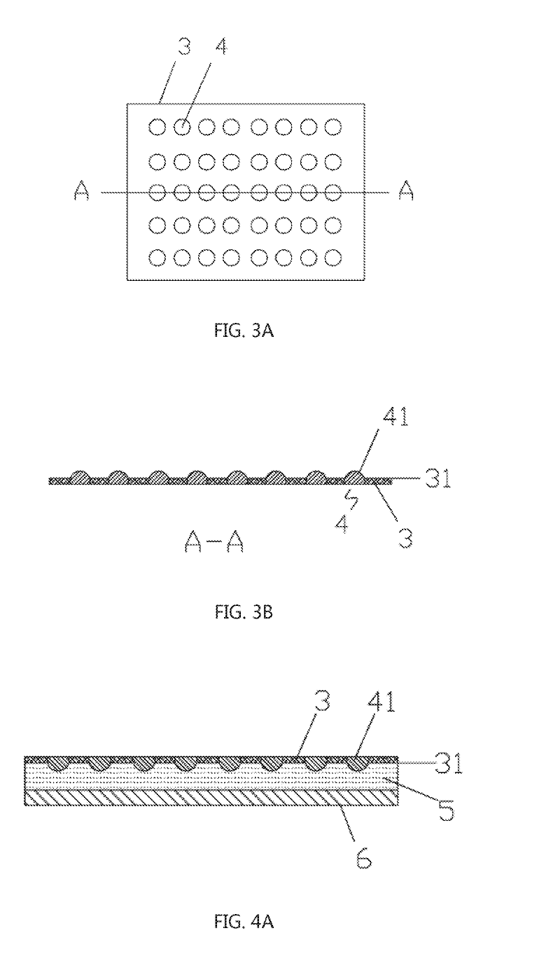

In order to solve the above problems, referring to FIG. 3A and FIG. 3B, an embodiment of the present disclosure provides an embossing plate 3 for manufacturing an alignment layer transfer plate. The embossing plate 3 includes an embossing plate body. A plurality of protrusions 41 distributed in an array are provided on an embossing surface 31 of the embossing plate body. In this embodiment, first, a plurality of through holes distributed in an array are formed on the embossing plate body, and a filler 4 is provided within each of the through holes. A portion of the filler 4 protrudes from the embossing surface 31 of the embossing plate body to form the protrusion 41.

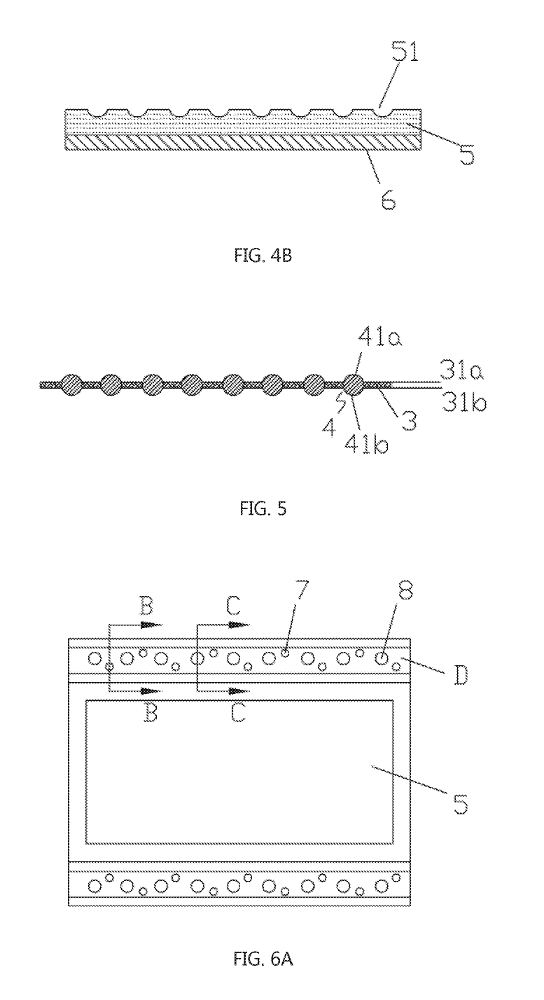

As shown in FIG. 4A, the above-described embossing plate 3 is pressed against the surface of the alignment layer transfer plate 5, and a plurality of protrusions 41 can uniformly form a pattern on the alignment layer transfer plate 5. After the alignment layer transfer plate 5 is separated from the embossing plate 3, as shown in FIG. 4B, the pattern having a higher uniformity can be obtained on the alignment layer transfer plate 5. When an alignment layer is manufactured using the alignment layer transfer plate 5, a thickness uniformity of the alignment layer and a quality of the surface of the alignment layer can be improved.

It should be noted that, in this embodiment, the embossing surface 31 having the protrusions 41 is formed only on one side of the embossing plate body. However, the present disclosure is not limited to this. The embossing surfaces 31 having the protrusions 41 may be formed on both sides of the embossing plate body. Specifically, FIG. 5 shows an embossing plate 3 according to an embodiment of the present disclosure. As compared with the above embodiment, as shown in FIG. 5, a first embossing surface 31a having protrusions 41a and a second embossing surface 31b having protrusions 41b are formed on both sides of the embossing plate body, respectively.

In an exemplary embodiment, two portions of the filler 4 protrude from the first embossing surface 31a and the second embossing surface 31b of the embossing plate body, respectively. Specifically, a first portion 41a of the filler 4 protrudes from the first embossing surface 31a of the embossing plate body; and a second portion 41b of the filler 4 protrudes from the second embossing surface 31b of the embossing plate body.

Optionally, the filler 4 may have a shape of sphere. The sphere is disposed in a through hole of the embossing plate body, and portions protruding from the first embossing plate surface 31a and the second embossing plate surface 31b of the embossing plate body are proximate to two hemispherical protrusions. When the above-mentioned embossing plate 3 is pressed against a surface of the alignment layer transfer plate 5, the hemispherical protrusions can be printed on the alignment layer transfer plate 5 into substantially hemispherical concave portions, thereby forming patterned structure of the alignment layer transfer plate 5. Of course, in practical applications, different patterns of the alignment layer transfer plate 5 can be employed as required, and the shape of the protrusions can be designed according to the patterns.

In practical applications, materials applicable for the filler 4 may include metal or glass, or other materials having sufficient hardness capable of being printed on the alignment layer transfer plate 5 to form patterns.

In practical applications, the manner of fixing the filler 4 to the embossing plate body may include the application of a colloid adhesive (not shown) between the through hole and the filler 4 to fix the filler 4 within the through hole, so as to achieve the fixing of the filler 4 to the embossing plate body.

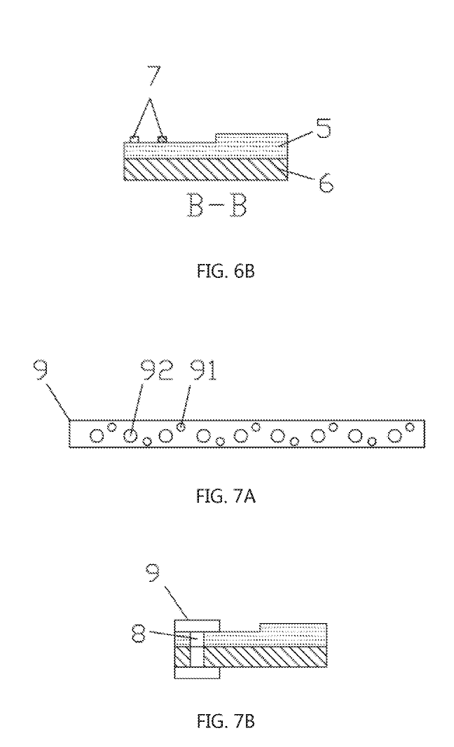

As another technical solution, FIGS. 6A and 6B illustrate an alignment layer transfer plate according to an embodiment of the present disclosure, including a substrate 6 and a transfer layer 5 disposed on the substrate 6. The patterns may be formed on the transfer layer 5 by using the embossing plate 3 according to the various embodiments of the present disclosure as described above.

In practical applications, the transfer layer 5 may be made of a resin material.

In this embodiment, a portion of the substrate 6 on both sides of the transfer layer 5 is provided with a clamp region D for mounting a clamp. This clamp is configured to fix the transfer layer 5 to a working table (not shown). A plurality of stoppers 7 are evenly distributed in the clamp region D. Further, as shown in FIG. 7A, a plurality of concave portions 91 are correspondingly provided on the clamp 9 for fixing the substrate 6. When the clamp 9 is mounted to the substrate 6, the stoppers 7 can be engaged with the respective concave portions 91. In this manner, the fixing of the alignment layer transfer plate 5 to the clamp 9 can be effectively enhanced, the relative displacement of the transfer layer (with respect to the working table) can be restricted, and the deformation of the transfer layer 5 can be reduced, thereby improving the lifetime of the transfer layer 5.

In practical applications, the stopper 7 can be a columnar stopper or a tapered stopper. The columnar stopper may be in a shape of a cylinder or a rectangular parallelepiped, and the tapered stopper may be in a shape of a truncated cone or a truncated triangle.

In practical applications, the substrate 6 serves as a carrier for the transfer layer 5. The substrate 6 can be made of PET (polyethylene terephthalate).

Optionally, the stopper 7 may be integrally formed with the transfer layer 5 to simplify the process flow.

Further, in this embodiment, a plurality of clamp mounting holes 8 are evenly distributed in the clamp region D, and the clamp mounting holes 8 penetrate through the transfer layer 5 and the substrate 6 in a thickness direction. As shown in FIG. 7A, a plurality of through holes 92 are correspondingly provided on the clamp 9. FIG. 7B is a diagram of mounting the clamp employed in an embodiment of the present disclosure, which is a cross-sectional view taken along a line C-C of FIG. 6A. In FIG. 7B, when the two clamps 9 sandwich the transfer layer 5 and the substrate 6, the mounting can be performed by sequentially passing bolts through the through holes 92 in the clamp 9 and clamp mounting holes 8.

By pressing the embossing plate 3 according to the various embodiments of the present disclosure as described above on the surface of the alignment layer transfer plate, the plurality of protrusions can form uniform patterns on the alignment layer transfer plate. Thus, the uniformity of the patterns on the alignment layer transfer plate can be improved. When the alignment layer is formed by using the alignment layer transfer plate, the thickness uniformity of the alignment layer and the quality of the surface of the alignment layer can be improved.

As another technical solution, FIG. 3A and FIG. 3B illustrate a method for manufacturing the embossing plate 3 according to an embodiment of the present disclosure. The method includes a step of:

providing an embossing plate body; and
forming a plurality of protrusions 41 distributed in an array on an embossing surface 31 of the embossing plate body.

In an exemplary embodiment, the step of providing the embossing plate body further includes:

forming a plurality of through holes distributed in an array on the embossing plate body.

The step of forming a plurality of protrusions 41 distributed in an array on the embossing surface 31 of the embossing plate body further includes: providing a filler 4 within each of the through holes such that a portion of the filler 4 protrudes from the embossing surface 31 of the embossing plate body to form the above-mentioned protrusions 41.

In an exemplary embodiment, the step of providing the filler 4 within each of the through holes further includes:
providing a liquid adhesive between the through hole and the filler 4; and curing the liquid adhesive to form a colloid adhesive.

The above-mentioned colloid adhesive is used to fix the filler 4 within the through hole, thereby achieving the fixing of the filler 4 to the embossing plate body.

As another technical solution, FIG. 6A and FIG. 6B illustrate a method for manufacturing an alignment layer transfer plate according to an embodiment of the present disclosure, including steps of:

providing a substrate 6;
forming a transfer layer in a liquid state on the substrate 6;
placing the embossing plate 3 according to above embodiments of the present disclosure on the transfer layer;
curing the transfer layer; and
separating the embossing plate 3 from the transfer layer to form patterns on the transfer layer.

In an exemplary embodiment, before placing the embossing plate 3 according to above embodiments of the present disclosure on the transfer layer, the method of manufacturing the alignment layer transfer plate may further include: providing an embossing plate body; and forming a plurality of protrusions 41 distributed in an array on an embossing surface 31 of the embossing plate body.

In an exemplary embodiment, the step of providing the embossing plate body further includes: forming a plurality of through holes distributed in an array on the embossing plate body.

The step of forming a plurality of protrusions 41 distributed in an array on the embossing surface 31 of the embossing plate body further includes: providing a filler 4 within each of the through holes such that a portion of the filler 4 protrudes from the embossing surface 31 of the embossing plate body to form the above-mentioned protrusions 41.

In an exemplary embodiment, the step of providing the filler 4 within each of the through holes, further includes: applying a liquid adhesive between the through hole and the filler 4; and curing the liquid adhesive to form a colloid adhesive.

In summary, in the embossing plate and the manufacturing method thereof, the alignment layer transfer plate and the manufacturing method thereof according to the present disclosure, the embossing plate comprises an embossing plate body, and a plurality of protrusions distributed in an array are disposed on the embossing surface of the embossing plate body. By pressing the above embossing plate against the surface of the alignment layer transfer plate, a plurality of protrusions can uniformly form patterns on the alignment layer transfer plate, thereby improving the pattern uniformity of the alignment layer transfer plate. Further, the thickness uniformity of the alignment layer and the quality of the surface of the alignment layer can be improved.

It should be understood that the embodiments described above are merely exemplary embodiments employed to explain the principles of the present disclosure. However, the present disclosure is not limited thereto. Various modifications and improvements can be made by those skilled in the art without departing from the spirit and scope of the disclosure, and these modifications and improvements are also considered to be within the scope of the disclosure.

1. An embossing plate for manufacturing an alignment layer transfer plate, wherein
the embossing plate comprises an embossing plate body, and a plurality of protrusions distributed in an array are provided on an embossing surface of the embossing plate body.

2. The embossing plate according to claim 1, wherein
a plurality of through holes distributed in an array are formed on the embossing plate body,
a filler is provided within each of the through holes, and
a portion of the filler protrudes from the embossing surface of the embossing plate body to form the protrusions.

3. The embossing plate according to claim 2, wherein
a first embossing surface and a second embossing surface are formed on both sides of the embossing plate body, respectively, and
two portions of the filler protrude from the first embossing surface and the second embossing surface of the embossing plate body, respectively.

4. The embossing plate according to claim 2, wherein
the filler is in a shape of sphere.

5. The embossing plate according to claim 2, wherein
the filler is made from metal or glass.

6. The embossing plate according to claim 2, wherein
a colloid adhesive is applied between the through hole and the filler to fix the filler within the through hole.

7. An alignment layer transfer plate, comprising a substrate and a transfer layer disposed on the substrate, wherein patterns are formed on the transfer layer by using the embossing plate according to claim 1.

8. The alignment layer transfer plate according to claim 7, wherein
a portion of the substrate on both sides of the transfer layer is provided with a clamp region,
a plurality of stoppers are evenly distributed in the clamp region,
a plurality of concave portions are correspondingly provided on the clamp for fixing the substrate; and
under the condition that the clamp is mounted to the substrate, the stoppers are engaged with the respective concave portions.

9. The alignment layer transfer plate according to claim 8, wherein
the stopper is in a columnar or a tapered shape.

10. The alignment layer transfer plate according to claim 8, wherein
the stopper is integrally formed with the transfer layer.

11. The alignment layer transfer plate according to claim 7, wherein
a plurality of through holes distributed in an array are formed on the embossing plate body,
a filler is provided within each of the through holes, and
a portion of the filler protrudes from the embossing surface of the embossing plate body to form the protrusions.

12. The alignment layer transfer plate according to claim 11, wherein
a first embossing surface and a second embossing surface are formed on both sides of the embossing plate body, respectively, and
two portions of the filler protrude from the first embossing surface and the second embossing surface of the embossing plate body, respectively.

13. The alignment layer transfer plate according to claim 11, wherein
a colloid adhesive is applied between the through hole and the filler to fix the filler within the through hole.

14. A method for manufacturing an embossing plate, comprising steps of:
providing an embossing plate body; and
forming a plurality of protrusions distributed in an array on an embossing surface of the embossing plate body.

15. The method for manufacturing embossing plate according to claim 14, wherein
the step of providing an embossing plate body further comprises:
forming a plurality of through holes distributed in an array on the embossing plate body, and
the step of forming a plurality of protrusions distributed in an array on an embossing surface of the embossing plate body further comprises:
providing a filler within each of the through holes such that a portion of the filler protrudes from the embossing surface of the embossing plate body to form the protrusions.

16. The method for manufacturing embossing plate according to claim 15, wherein the step of providing a filler within each of the through holes further comprises:
providing a liquid adhesive between the through hole and the filler; and
curing the liquid adhesive to form a colloid adhesive.

17. A method for manufacturing an alignment layer transfer plate, comprising steps of:
providing a substrate;
forming a transfer layer in a liquid state on the substrate;
placing the embossing plate according to claim 1 on the transfer layer;
curing the transfer layer; and
separating the embossing plate from the transfer layer to form patterns on the transfer layer.

18. The method according to claim 17, wherein before placing the embossing plate on the transfer layer, the method further comprises:
providing an embossing plate body; and
forming a plurality of protrusions distributed in an array on an embossing surface of the embossing plate body.

19. The method according to claim 18, wherein
the step of providing the embossing plate body further comprises:
forming a plurality of through holes distributed in an array on the embossing plate body, and
the step of forming a plurality of protrusions distributed in an array on an embossing surface of the embossing plate body further comprises:
providing a filler within each of the through holes such that a portion of the filler protrudes from the embossing surface of the embossing plate body to form the protrusions.

20. The method according to claim 19, wherein the step of providing a filler within each of the through holes further comprises:
providing a liquid adhesive between the through hole and the filler; and
curing the liquid adhesive to form a colloid adhesive.
